(19) United States
(12) Patent Application Publication
(10) Pub. No.: US 2023/0350805 A1
(43) Pub. Date: Nov. 2, 2023

(54) Technique for Overriding Memory Attributes

(71) Applicant: Cadence Design Systems, Inc., San Jose, CA (US)

(72) Inventors: Robert T. Golla, Austin, TX (US); Thomas M. Wicki, Palo Alto, CA (US)

(21) Appl. No.: 17/661,427

(22) Filed: Apr. 29, 2022

(51) Int. Cl. G06F 12/0837; G06F 12/0877; G06F 9/30

(52) U.S. Cl. CPC G06F 12/0837; G06F 12/0877; G06F 9/30138

(57) ABSTRACT

Techniques are disclosed relating to an apparatus that includes a plurality of memory access control registers that are programmable with respective address ranges within an address space. The apparatus further includes a memory access circuit configured to receive a command for performing a memory access, the command specifying an address corresponding to a location in a memory circuit. In response to the address being located within an address range of a particular one of the plurality of memory access control registers, the memory access circuit is configured to perform the command using override memory parameters that have been programmed into the particular memory access control register instead of a default set of attributes for the address space.

### BACKGROUND

### Technical Field

This disclosure relates to processing in computer systems and more particularly to managing memory access attributes in a processor.

### Description of the Related Art

Various computer systems may utilize one or more different types of memory circuits, accessed, for example, using addresses mapped by a system memory map to the memory circuits within the computer system's address space. As used herein, an “address space” refers to a range of addresses implemented in a computer system while a “system memory map” assigns respective ones of the range of addresses to individual locations in the memory circuits and register circuits included in the computer system. For example, a given computer system may include any one or more of: registers associated with various peripherals, random-access memory (RAM), hard-disk drives (HDD), solid-state drives (SSD), and so forth. Individual ones of these registers and memory locations are assigned respective addresses in the system memory map such that a processor may be able to read and/or write to a specific one using the respective address.

For various reasons, certain memory addresses may be treated different from other addresses. For example, a status register of a peripheral circuit may be read-only, and may change a state after being read. A value of such a register may not be permitted to be cached, and may therefore have a non-cacheable attribute. In addition, such a register may include an attribute to indicate that reading the location has a side-effect (e.g., the state change), as well as an attribute to enforce access ordering. To manage accesses to the various memory locations with different attributes, memory commands to a given address may be modified to restrict access to a target address based on the attributes of the target address. These attributes may be set by default based on a hardware design, and/or boot code of the computer system. To simplify the management, memory locations with similar attributes may be grouped together. Such an organization may limit flexibility of the computer system, and may introduce issues when circuits are added or removed from the computer system.

### BRIEF DESCRIPTION OF THE DRAWINGS

FIG. 1 is a block diagram of an embodiment of a computer system, including a processor core and a memory circuit.

FIG. 2 illustrates a block diagram of an embodiment of memory access control registers in a processor core.

FIG. 3 depicts a block diagram of an embodiment of a memory circuit and memory access control registers mapped to address ranges of the memory circuit.

FIG. 4 shows block diagrams of two different embodiments of a processor core.

FIG. 5 illustrates an embodiment of an example set of memory access control registers and three examples of memory commands modified based on the example set.

FIG. 6 depicts an embodiment of a multicore computer system.

FIG. 7 shows a flow diagram depicting an embodiment of a method for managing access of memory circuits in an address space of a computer system.

FIG. 8 depicts a flow diagram depicting an embodiment of a method for managing varying priorities of a set of memory access control registers.

FIG. 9 is a block diagram of an embodiment of a system.

### DETAILED DESCRIPTION OF EMBODIMENTS

In some computer systems, different memory address ranges may have independently controllable physical memory attributes. These attributes may include a cacheable attribute indicating if a particular range is allowed to be cached, a side-effect attribute indicating if read and/or write access to a particular range can have side effects (e.g., changing a value stored in a respective location), an ordering attribute indicating that read and/or write accesses to a respective location must be ordered (e.g., processed in the same order as load and store instructions appear in the instruction flow), and the like. In a typical embodiment, default values for such attributes may be specified using some bits of a memory address, resulting in all memory locations within a particular address range to have the same attributes. No mechanism for defining different levels of granularity in the sizes of respective memory ranges may be available. Accordingly, such an embodiment may provide no recourse for modifying the default attributes for a smaller range of addresses falling within an address range with a particular set of default attributes. Such a lack of resolution for defining desired attributes for smaller portions of memory may result in larger-than-necessary blocks of memory being allocated to a particular use, thereby reducing, or even eliminating, an ability to reallocate unused portions for other uses.

Techniques are described herein that include creating an override for default memory attributes for certain address ranges. In one disclosed embodiment, a first set of registers may store default access information for an entire address space, or a large portion of the address space. A second set of registers, referred to herein as “Memory Access Control Override” (MACO) registers, may store override information for a smaller portion of the address space. Each entry in the second set of registers may specify a start address, a range size, and control bits specifying the override attributes. In some embodiments, entries in the MACO register set may be individually enabled and/or locked to prevent tampering.

Use of such techniques for assigning memory attributes may reduce a minimum amount of a memory that is assigned to a given set of attributes, allowing for a finer resolution. This finer resolution may, in turn, allow for smaller portions of memory to be overridden with different attributes, and promoting a more efficient allocation of various address ranges, in turn, reducing an amount of memory address space to be used by a particular application or other type of software process. Efficient use of memory may reduce power consumption of a system, and/or allow more software processes to be executed concurrently.

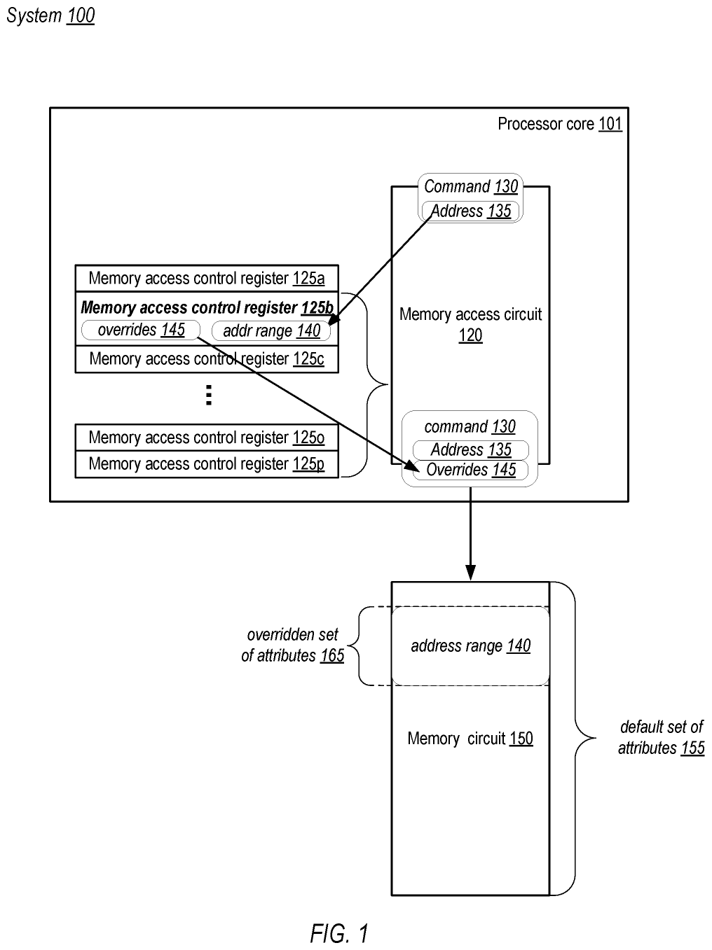

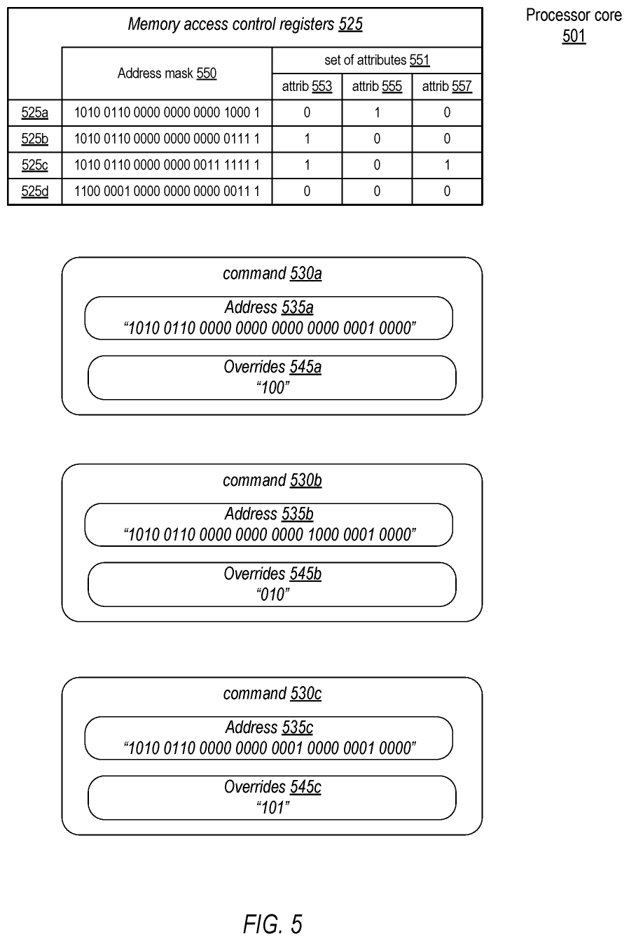

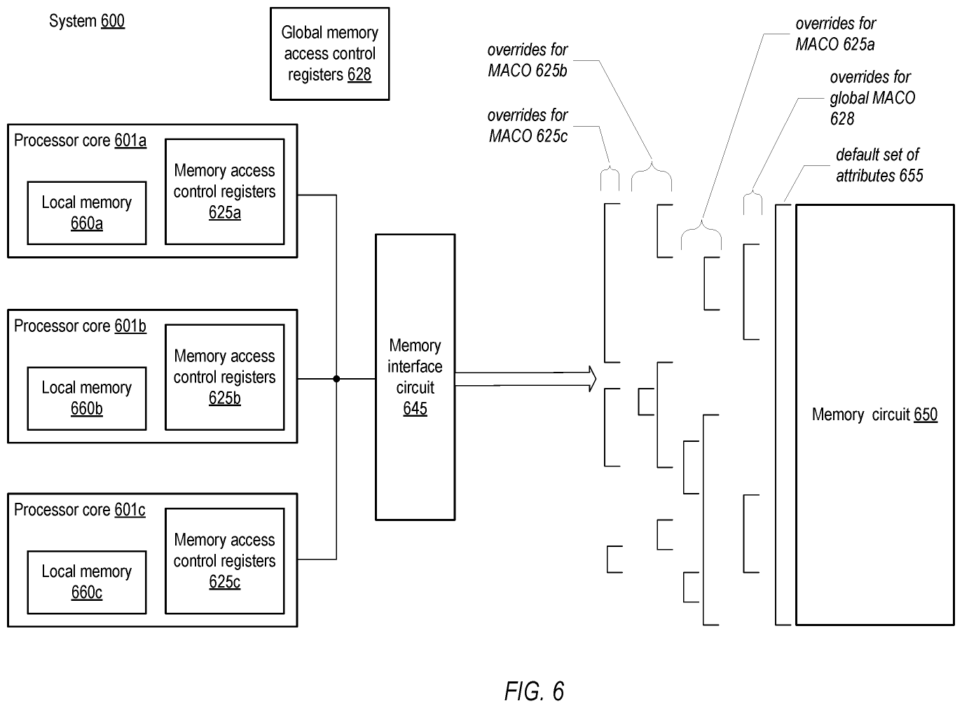

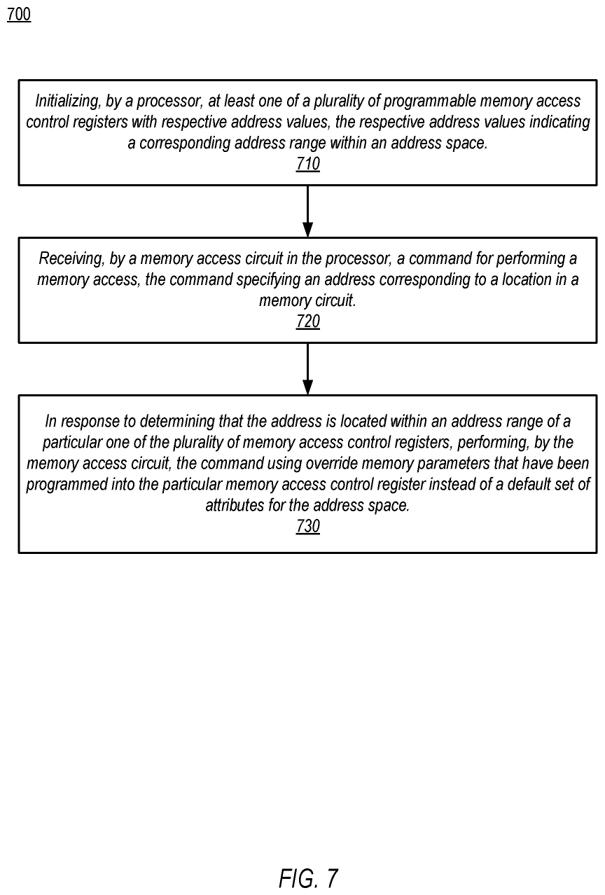

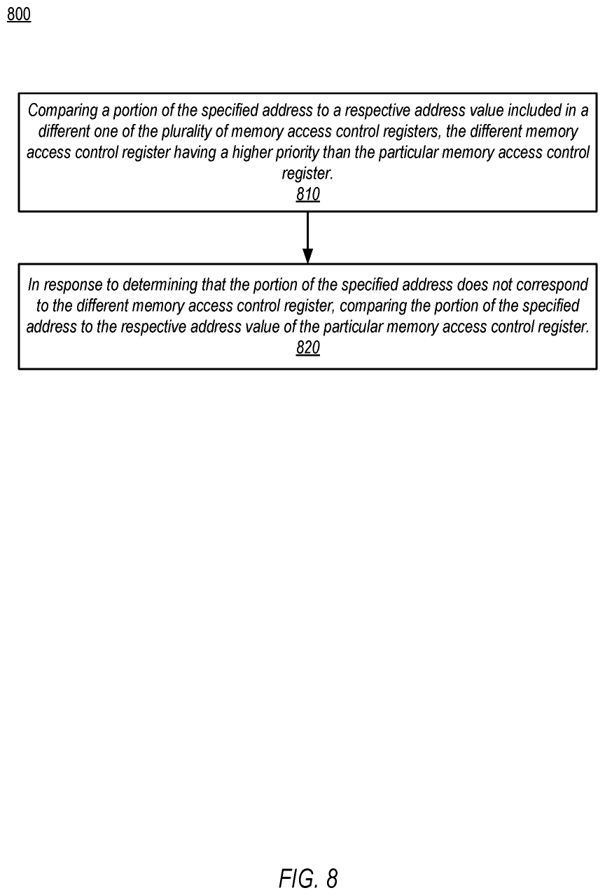

This disclosure initially describes, with reference to FIGS. 1-4, embodiments of a computer system and components thereof that utilize memory access control (e.g., MACO) registers to manage memory attributes within an address space. With reference to FIG. 5, the disclosure describes several examples of how memory commands utilize the memory access control registers to determine attributes of memory locations associated with the commands. FIG. 6 provides an example of a multi-core computer system in which the disclosed techniques may be employed. FIGS. 7 and 8 show example methods related to use of memory access control registers.

### System Overview

A block diagram depicting an embodiment of a computer system is illustrated in FIG. 1. As shown, system 100 includes processor core 101 and memory circuit 150. Processor core 101 includes memory access circuit 120 as well as memory access control registers 125a-125p (collectively memory access control registers 125). Memory access circuit 120 receives a fetch or load/store command 130, including address 135, and uses memory access control registers 125 to determine overrides 145 to be used when command 130 is performed. System 100 may be any suitable computer system, including desktop computers, laptop computers, tablet computers, smartphones, and the like. In various embodiments, system 100 may be implemented as a peripheral device such as an HDD or SSD storage device, a networking device, a graphics device, or the like.

As shown, processor core 101 is configured to perform operations for instructions of an application or other type of software process. As a part of performing instructions, processor core 101 may retrieve information from memory circuit 150. Any access of memory circuit 150 as part of command execution is referred to herein as a “memory access.” Memory accesses by processor core 101 include retrieving instructions from memory circuit 150 (referred to herein as an “instruction fetch”), as well as memory accesses that occur as part of execution of an instruction that results in data used or generated by a given instruction being loaded from, and/or stored to, memory circuit 150. Unless described otherwise, memory accesses refer to instruction fetches and data load/store instructions.

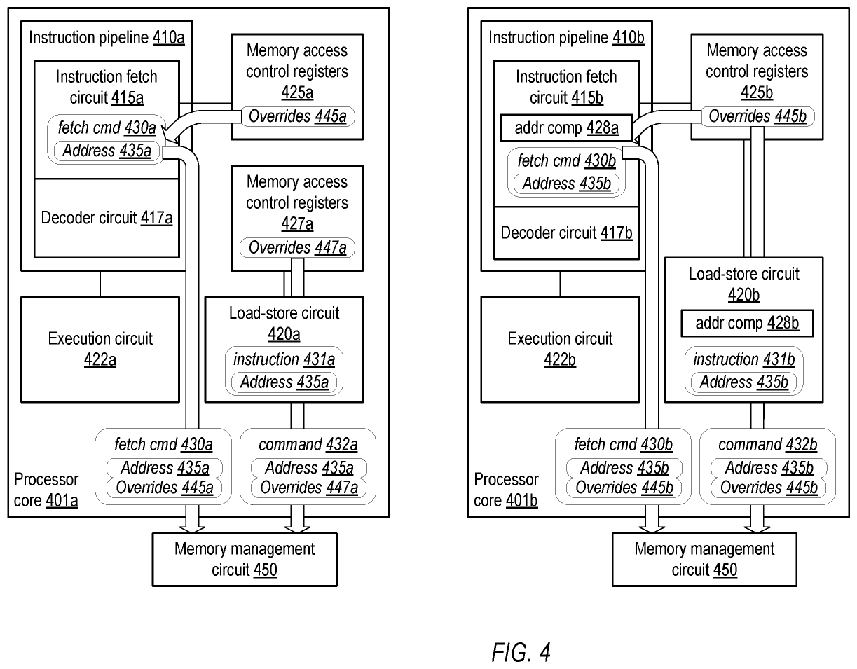

Processor core 101 utilizes memory access circuit 120 to perform memory accesses to retrieve instructions and information related to instructions as well as loading and/or storing data that is associated with an instruction being executed. Memory access circuit 120 may include an instruction fetch circuit and/or a load-store circuit. Additional details regarding instruction fetch circuits and load-store circuits is disclosed below in regards to FIG. 4.

Memory circuit 150, as illustrated, includes one or more types of memory with a plurality of locations that are mapped to respective addresses of an address space supported by processor core 101. Information to be accessed by memory access circuit 120 may be retrieved by performing a command to access the desired information using one or more addresses mapped to memory circuit 150.

The locations in memory circuit 150 are accessed using a default set of attributes 155. This set of attributes 155 may include a single set of attributes to be applied to all locations in memory circuit 150, or memory circuit 150 may include a plurality of address ranges that each have a respective set of default attributes. The default set of attributes may be hardcoded into logic circuits of system 100 or may be programmed (e.g., during a system boot) into one or more registers. This default set of attributes 155 may depend on properties of a memory circuit at a given address. Default attributes may be set to match the properties of the underlying circuits at various memory locations. The set of attributes for an address space of processor core 101 may include, for example, an indication of whether information in a given address is cacheable, an indication of whether information in a given address has side-effects when accessed. Other types of attributes may include an indication if accesses to the given address requires ordering, and the like.

To access memory circuit 150, processor core 101 includes memory access control registers 125 that are programmable with respective address ranges within an address space. Ones of memory access control registers 125 may include an address mask field, a value of which determines a start address and a size (e.g., an end address) for a respective address range, such as address (addr) range 140 shown for memory access control register 125b. Ones of memory access control registers 125 may further include an override value, such as overrides 145 in memory access control register 125b. A value of overrides 145 provides values of attributes for overriding the default set of attributes 155 for memory locations of memory circuit 150 included within address range 140, such as indicated by overridden set of attributes 165.

As illustrated, memory access circuit 120 is configured to receive command 130 for performing a memory access to memory circuit 150. Command 130 specifies address 135 that corresponds to a location in memory circuit 150. Memory access circuit 120 compares address 135 to respective address ranges that are currently programmed into address mask fields of ones of memory access control registers 125. Based on this comparison, memory access circuit 120 may determine that address 135 falls within address range 140 as indicated by memory access control register 125b.

In response to address 135 being located within address range 140 of memory access control register 125b, memory access circuit 120 performs command 130 using override memory parameters that have been programmed into memory access control register 125b (e.g., overrides 145). Overrides 145 are used instead of the default set of attributes 155 for the address space of processor core 101. To perform command 130 using overrides 145, memory access circuit 120 is configured, as illustrated, to append at least one value of overrides 145 from memory access control register 125b to command 130. For example, only a portion of overrides 145 may be applicable to command 130, so this portion may be appended to command 130. Some attributes, such as cacheability, may be appended to command 130 to prevent, e.g., an intervening cache circuit from attempting to cache data from a memory location indicated as non-cacheable. Other attributes, such as indications of side-effects, may affect how memory command 130 is performed by memory access circuit 120, and may not need to be appended onto command 130. For example, if address 135 is indicated as having a side-effect, then memory access circuit 120 may not execute command 130 speculatively, a store command might not be coalesced with previous store commands to address 135, and/or a load command for address 135 may not be forwarded from a store queue holding a store command to address 135.

For memory access circuit 120, performing command 130 may include, after the appending, sending the modified command 130 to memory circuit 150. In various embodiments, sending command 130 may include sending the command to a memory management circuit that may be included in memory circuit 150, in processor core 101, in a separate circuit that resides between memory circuit 150 and processor core 101, or a combination thereof. A memory management circuit may include and/or otherwise utilize one or more memory controller circuits for accessing data in a system memory, e.g., a dynamic random-access memory (DRAM) or other type of RAM. A memory management circuit may further include or use one or more cache controller circuits to access one or more levels of cache memory. Since one example attribute is whether a particular address is cacheable, one of overrides 145 included in modified command 130 may be an indication that the value at address 135 is not cacheable, thereby causing memory management circuits to avoid use of any associated cache circuits when accessing one or more values associated with address 135, and instead perform modified command 130 using the system memory.

It is noted that the system of FIG. 1 is merely an example for illustrating the disclosed concepts. In other embodiments, additional circuits may be included. For example, FIG. 1 only shows portions of a processor core, omitting various circuits for clarity, such as instruction decoder circuits and execution circuits. As disclosed, other embodiments may include one or more memory controller circuits as well as one or more cache circuits.

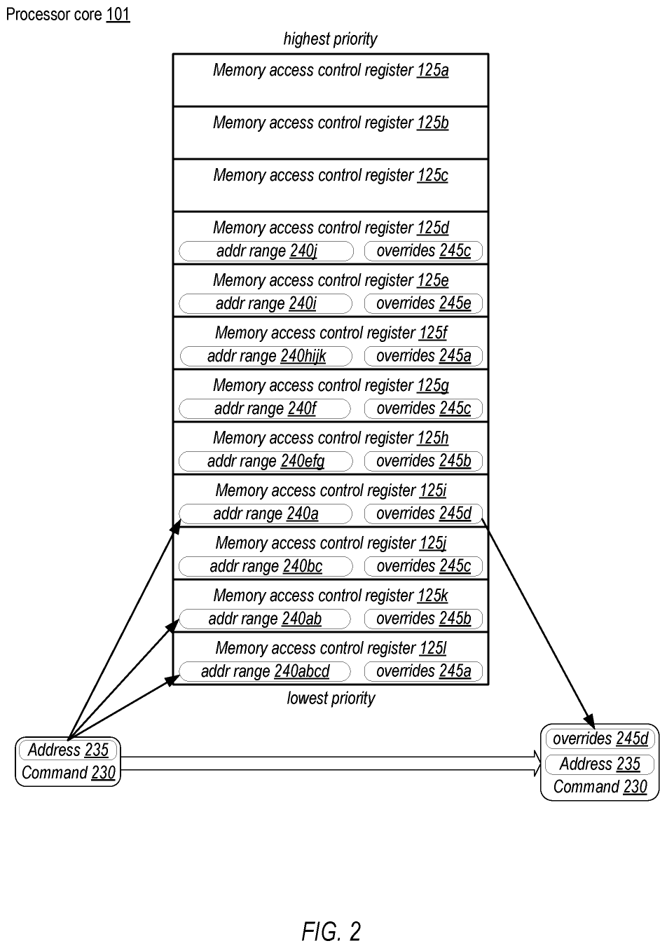

As disclosed, processor core 101 uses a plurality of memory access control registers to determine override parameters for a variety of address ranges. Such registers may be implemented using a variety of schemes. FIG. 2 illustrates an example of how a plurality of memory access control registers may be used to define override values for a plurality of address ranges.

Moving to FIG. 2, an embodiment of a set of memory access control registers in a processor core is shown. As illustrated, memory access control registers 125a-1251 are included in processor core 101 of FIG. 1. Memory access control registers 125a-1251 are shown arranged in an order of priority from highest priority to lowest priority. In addition, memory access control registers 125d-1251 are shown programmed with respective address (addr) ranges 240 as well as with one of overrides 245a-245e. The address ranges 240 vary in size and, in some cases, overlap. For example, address range 240abcd is inclusive of address ranges 240a, 240b, 240c, and 240d. In a like manner, address range 240ab includes address ranges 240a and 240b and is, therefore, included within address range 240abcd.

Each of memory access control registers 125a-1251 may be assigned a respective priority. As depicted, memory access control registers 125a-1251 have respective priority levels based on respective locations of the plurality of memory access control registers within a register block. Each location in this register block may be assigned to one or more addresses within an address space of processor core 101. In some embodiments, a value of the assigned address may correspond to the relative priority of the respective register. For example, a lower address value may correspond to a higher priority, or vice versa.

The relative priority of a given one of memory access control registers 125a-1251 may determine which register is used to set override values if an address of a command 130 falls within a range of more than one of the memory access control registers 125a-1251. In the illustrated example, a memory access circuit (e.g., memory access circuit 120 of FIG. 1), receives command 230 with address 235. Address 235, as depicted, falls within a memory range of memory access control registers 125i, 125k, and 125l. Memory access circuit is further configured to use the overrides 245d from memory access control register 125i in response to a determination that memory access control register 125i has the highest priority of the three memory access control registers that have corresponding address ranges. Memory access circuit 120 may, therefore, perform command 230 using overrides 245d.

It is noted that the register prioritization depicted in FIG. 2 is presented as an example. Other prioritization schemes are known and contemplated for use with the disclosed concepts. In other embodiments, for example, memory access control registers 125 may be prioritized using a value programmed into each register. In some embodiments, prioritization between registers with overlapping address ranges may be determined based on a size of the respective address ranges. For example, memory access control register 125i may be prioritized over memory access control registers 125k and 1251 based on having a smaller address range.

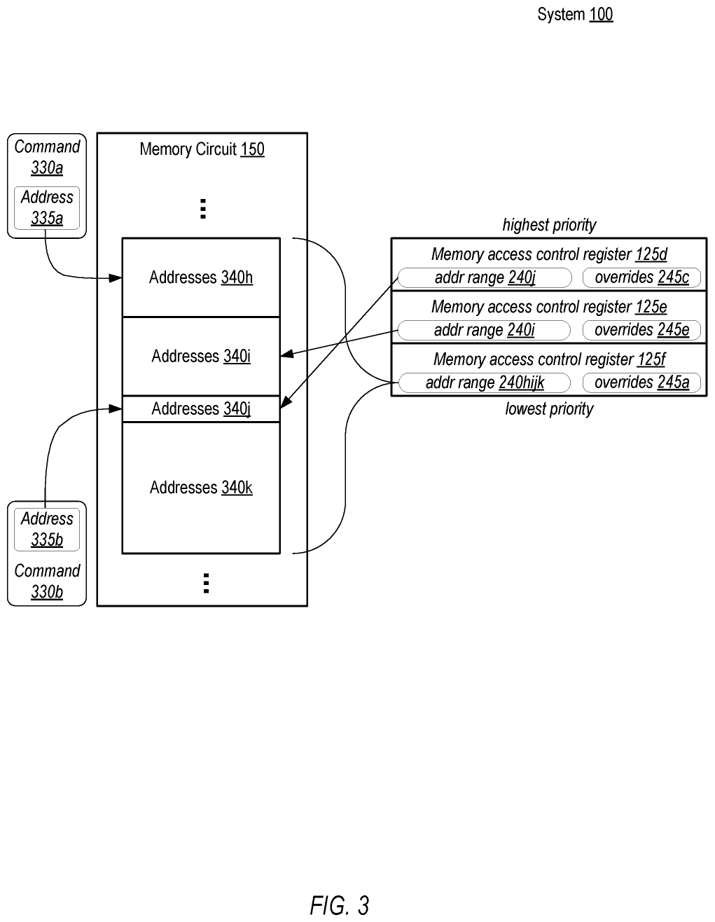

FIG. 2 illustrates a prioritization scheme for use with the disclosed memory access control registers. Address ranges may be determined for given ones of the memory access control registers using various methods. An example of assigning address ranges to ones of the memory access control registers is illustrated in FIG. 3.

Turning to FIG. 3, another embodiment of system 100 is depicted. System 100, in FIG. 3, is shown with memory circuit 150 and memory access control registers 125d-125f. Memory access control registers 125d-125f are shown with the same address ranges and overrides as shown in FIG. 2. FIG. 3 illustrates an example of how these address ranges may be mapped into memory circuit 150.

Memory circuit 150 is shown with four particular ranges of addresses intended to represent a portion of an overall memory space included within memory circuit 150. These four ranges, addresses 340h-340k, correspond to addresses ranges defined by the address range values programmed into memory access control registers 125d-125f. Memory access control register 125f is programmed with address range 240hijk, which includes all four illustrated ranges, addresses 340h-340k. Memory access control register 125d is programmed with address range 240j, corresponding to addresses 340j. In a similar manner, memory access control register 125e is programmed with address range 240i, corresponding to addresses 340i. Each of the ranges of addresses 340 may be determined arbitrarily, based on the values of address ranges 240 programmed into memory access control registers 125. Accordingly, the different sets of addresses 340h-340k may not have any physical bounds other than the values of address ranges 240. Sizes of each of addresses 340h-340k may, therefore, be changed by changing a value of a corresponding one or more of address ranges 240. Additional details associated with mapping memory access control registers 125 to various ranges of addresses is disclosed below in reference to FIG. 5.

An example of how processor core 101 may use memory access control registers 125 to determine corresponding overrides for two different commands is depicted with commands 330a and 330b. Processor core 101 generates command 330a for performing a memory access to memory circuit 150. Command 330a includes address 335a, which corresponds to one of addresses 340h. Using memory access circuit 120, processor core 101 may determine that address 335a is within address range 240hijk of memory access control register 125f, but is not within address range 240i or 240j as programmed into memory access control registers 125d and 125e. Accordingly, processor core 101 may perform command 330a using overrides 245a as specified by memory access control register 125f.

At a different time, processor core 101 may generate command 330b for performing a different memory access, command 330b specifying address 335b that is located within addresses 340j. Again using memory access circuit 120, processor core 101 may determine that address 335b is, similar to address 335a, within address range 240hijk of memory access control register 125f. In response to determining that address 335b is also located within address range 240j of memory access control register 125d, processor core 101 may perform command 330b using overrides 245c that have been programmed into memory access control register 125d instead of overrides 245a of memory access control register 125f. Processor core 101 may use overrides 245c in response to determining that, memory access control register 125d has a higher priority than memory access control register 125f.

In some embodiments, an address value of a particular command (e.g., address 335a and/or 335b) may correspond to a virtual address. In such embodiments, processor core 101 may map address 335a of command 330a from the virtual address to a corresponding physical address. As used herein, a virtual address corresponds to a logical address used to map an address space of a processor core to physical addresses of included memory circuits, such as memory circuit 150. Virtual addresses may be used in application code, allow such code to be relocated into different portions of RAM when the application is launched. Virtual addresses included in the application code may then be mapped into the physical address space depending on where in the RAM the current instance of the application has been loaded. After the virtual address 335a has been mapped into a physical address 335a, processor core 101 may (e.g., using memory access circuit 120) compare the converted physical address 335a to address ranges 240 of the memory access control registers 125.

It is noted that FIG. 3 is merely an example to demonstrate how different address ranges may be mapped into a memory circuit. Although only three memory access control registers are shown, associated with four different sets of addresses in the memory circuit, other embodiments may include any suitable number of memory access control registers programmed to establish any suitable number of address ranges.

FIGS. 1-3 illustrate block diagrams and examples associated with processor cores. Commands used in the examples have not been associated with any particular type of processor core pipeline. In FIG. 4, two examples are depicted that show how memory access control registers may be used to support different pipelines within the processor core.

Proceeding to FIG. 4, two embodiments of a processor core are shown, processor cores 401a and 401b. In various embodiments, either of processor cores 401a and 401b may correspond to processor core 101 in FIGS. 1 and 2. As shown, processor cores 401a and 401b illustrate how memory access control registers may be used to support different pipelines within the processor core. Each of processor cores 401a and 401b includes a respective one of instruction pipelines 410a and 410b that each include corresponding ones of instruction fetch circuits 415a and 415b and decoder circuits 417a and 417b. Each of processor cores 401a and 401b also includes a respective one of load-store circuits 420a and 420b and execution circuits 422a and 422b. Processor cores 401a and 401b also include at least one set of memory access control registers 425a, 427a, and 425b.

As illustrated, instruction pipelines 410a and 410b may be used to fetch a stream of instructions, decode instruction op-codes, and assign and issue ready-to-perform instructions to one of a plurality of execution units, such as execution circuits 422a and 422b and load-store circuits 420a and 420b. Load-store circuits 420a and 420b, are examples of one type of execution unit, used to execute memory access commands. Execution circuits 422a and 422b may be used to execute other types of instructions, such as control flow, integer arithmetic, and/or logic instructions. In some embodiments, additional execution units may be included, floating point units, hardware divider circuits, multiply and accumulate circuits, and the like.

Load-store circuits 420a and 420b may be used to load data to be used as an operand of one or more instructions. For example, a integer operation may be a multiply instruction between two data words. Load-store circuits 420a and 420b may load each of the data words and have the words buffered and ready for use when the respective multiply instruction is ready to be issued to, e.g., execution circuits 422a and 422b, respectively. In some cases, one or both of the data words may not be locally available (e.g., in a local data cache and/or in a core register) and therefore load-store circuits 420a and 420b may issue a memory access command to retrieve the missing data word or words.

In the embodiment of processor core 401a, instruction fetch circuit 415a and load-store circuit 420a are configured to use memory access control registers 425a for instruction fetch memory access commands (e.g., fetch command 430a), while load-store circuit 420a is configured to use memory access control registers 427a for load and/or store operations resulting from execution of instruction 431a. As shown, fetch command 430a, with address 435a, is received by instruction fetch circuit 415a. Since fetch command 430a is received from instruction fetch circuit 415a, address 435a is compared to address ranges programmed into ones of memory access control registers 425a. After identifying a matching range, fetch command 430a is performed (e.g., sent to memory management circuit 450 to be fulfilled) using overrides 445a from memory access control registers 425a.

While fetch command 430a is processed by instruction fetch circuit 415a, previously fetched instruction 431a, also including address 435a, is decoded by decoder circuit 417a. As shown, instruction pipeline 410a determines that instruction 431a includes a load and/or store operation to be performed at address 435a. Accordingly, instruction 431a is directed to load-store circuit 420a. Instruction 431a may be received at a same or different time as command 430a and processing of each command may overlap. Since instruction 431a is performed by load-store circuit 420a, address 435a is compared to address ranges programmed into ones of memory access control registers 427a, rather than memory access control registers 425a. If a matching address range is identified, load-store circuit performs instruction 431a, including generating command 432a using overrides 447a from memory access control registers 427a, which is then sent to memory management circuit 450 to be fulfilled.

Accordingly, although commands 430a and 432a use a same address 435a, different sets of override values may be used in response to the two commands being processed by different circuits. Such an arrangement may allow for setting memory attributes individually such that instruction fetches are processed differently from data loads/stores. For example, instruction fetches may be granted more privileges in memory locations where instructions are stored and fewer privileges where data is stored, and vice versa for data loads/stores.

In the embodiment of processor core 401b, instruction fetch circuit 415b is configured to use address comparator 428a to compare addresses of instruction fetch commands (e.g., instruction fetch command 430b) to memory access control registers 425b, while load-store circuit 420b is configured to use address comparator 428b to compare addresses of load/store operations resulting from execution of instruction 431b to memory access control registers 425b. As shown, fetch command 430b, including address 435b, is received by instruction fetch circuit 415b and, therefore, address 435b is latched in address comparator 428a. Via address comparator 428a, address 435b is compared to address ranges programmed into ones of memory access control registers 425b.

While fetch command 430b is processed by instruction fetch circuit 415b, previously fetched instruction 431b, also including address 435b, is decoded by decoder circuit 417b. As illustrated, instruction pipeline 410b determines that instruction 431b includes a load and/or store operation to be performed at address 435b. Accordingly, instruction 431b is directed to load-store circuit 420b. In a similar manner as described above, instruction 431b may be received at a same or different time as fetch command 430b and processing of each may overlap. Since instruction 431b is performed by load-store circuit 420b, address 435b is latched in address comparator 428b. Address 435b is again compared, this time using address comparator 428b, to address ranges programmed into ones of memory access control registers 425b. If a matching address range is identified for address 435b, then both fetch command 430b and instruction 431b may be performed using the same set of overrides 445b from memory access control registers 425b. Instruction fetch circuit 415b sends fetch command 430b to memory management circuit 450 using overrides 445b. Similarly, load-store circuit 420b generates command 432b based on instruction 431b and overrides 445b and sends command 432b to memory management circuit 450.

Accordingly, although commands 430b and 432b are sent by different circuits, a same set of override values may be used in response to the two commands using the same address 435b. Such an arrangement may reduce size and power consumption in the processor core by supporting a single set of memory access control registers rather than two sets.

It is noted that FIG. 4 is merely an example for describing the disclosed techniques. Although two embodiments are shown, other suitable embodiments are contemplated. Although not shown, address comparators may be included in processor core 401a for latching and comparing addresses from received commands to address ranges in ones of the memory access control registers.

FIGS. 2 and 3 illustrated examples associated with mapping memory access control registers to an address space using an address mask field. Address mask fields may be implemented using a variety of techniques. An example technique is depicted in FIG. 5.

### Examples of Using Memory Access Control Registers

Moving now to FIG. 5, another embodiment of memory access control registers is depicted. As illustrated, processor core 501 includes memory access control registers 525. In some embodiments, processor core 501 may correspond to processor core 101 in FIGS. 1 and 2, or to either of processor cores 401a and 401b in FIG. 4. Memory access control registers 525 includes four registers (525a-525d), each shown with four fields: address mask 550, and three attributes (attrib) 553, 555, and 557. A value of address mask 550 determines a start address and a size for the respective address range for a respective one of memory access control registers 525. Attributes 553:555:557 combine to form a respective set of attributes 551 for respective ones of memory access control registers 525. For example, attribute 553 may be an indication of whether information in a given address is cacheable. Attribute 555 may be an indication of whether information in a given address has side-effects when accessed. Attribute 557 may be an indication whether read and/or write access ordering must be enforced.

As shown, address mask 550 for memory access control register 525a is programmed to a value of 0b 1010 0110 0000 0000 0000 1000 1. It is noted that this is a 25-bit value. In the present example, a 32-bit address value is assumed. The 25-bit value in address mask 550 corresponds to the upper 25 bits of the 32-bit address, meaning that the least significant seven bits of an address cannot be programmed in the present example. To determine a size of a programmed address range, a first ‘0’ value, starting from the right-most, least-significant bit (LSB) of address mask 550, establishes the block size to be represented by a given memory access control register 525. If all bits of address mask 550 are programmed to ‘1,’ then the respective memory access control register 525 is disabled and not used to override any locations in the corresponding address space.

For memory access control register 525a, the first zero from the LSB of address mask 550 is in the second bit position, after the ‘1’ in the LSB position. Accordingly, address mask 550 of memory access control register 525a defines an address range bounded by the lower nine bits of the 32-bit address (nine bits including the first ‘0’ and all less significant bits), which corresponds to an address block size of 512 bytes. The starting address is determined by the remaining bits of greater significance than the first ‘0.’ In memory access control register 525a, the starting address is 0b 1010 0110 0000 0000 0000 100n nnnn nnnn, where ‘n’ represents a value of either ‘0’ or ‘1.’ Accordingly, all address values from 0b 1010 0110 0000 0000 0000 1000 0000 0000 to 0b 1010 0110 0000 0000 0000 1001 1111 1111 fall within the address range of memory access control register 525a.

Attributes for memory access control register 525a are set to 010 for attributes 553:555:557. For each attribute, a value of ‘1’ may indicate the corresponding attribute is applied. Accordingly, attribute 553 (‘0’) indicates values in the address range are not cacheable, attribute 555 (‘1’) indicates accesses to the address range have side-effects, and attribute 557 (‘0’) indicates ordering of accesses to locations in the address range is not required.

In a similar fashion, it can be determined that memory access control register 525b has an address range from 0b 1010 0110 0000 0000 0000 0000 0000 0000 to 0b 1010 0110 0000 0000 0000 1111 1111 1111, with a size of 4K bytes. Attributes are that the range is cacheable, has no side-effects, and access ordering is not required. Memory access control register 525c has an address range from 0b 1010 0110 0000 0000 0000 0000 0000 0000 to 0b 1010 0110 0000 0000 0111 1111 1111 1111, with a size of 32K bytes. Attributes are that the range is cacheable, has no side-effects, and access ordering is required. Memory access control register 525d has an address range from 0b 1100 0001 0000 0000 0000 0000 0000 0000 to 0b 1100 0001 0000 0000 0000 0111 1111 1111, with a size of 2K bytes. Attributes are that the range is not cacheable, has no side-effects, and access ordering is not required.

In some embodiments, the address mask value and/or attribute override values of a single entry might be spread over several registers instead of a single register. For example, to define a set of override attributes for a give address range, the address mask value may extend across memory access control registers 525a and 525b to enable a mask value that is greater than the 25 bits that are available in a single one of memory access control registers 525. In such embodiments, a portion of one or both of memory access control registers 525a and 525b may include a particular value to indicate the extension across the two registers. For example, the four MSBs of memory access control register 525a may be set to the particular value (e.g. “1111” or “0000”) to indicate memory access control registers 525a and 525b are to be used as a single entry.

It is noted that the address range of memory access control register 525c includes the address range of memory access control register 525b, which in turn, includes the address range of memory access control register 525a. The address range of memory access control register 525d does not overlap with the other three address ranges. For the illustrated example, memory access control register 525a has a highest priority of the four registers, followed in order by 525b, 525c, and 525d. Accordingly, by using smaller sized address ranges for the higher priority registers than for the lower priority registers, hierarchal sets of address ranges may be defined, allowing for smaller subsets of address ranges to have different attributes than the surrounding addresses. For example, instruction code for an application may be loaded into a range of addresses in RAM and then assigned a particular set of attributes (e.g., to allow caching of code) using a first memory access control register with a low priority. Then a smaller range of addresses within the code (e.g., a data table defined within the code space) may be re-assigned a different set of attributes to prevent that particular range from being cached.

Three example memory access commands, commands 530a-530c, are illustrated to show how a particular address value may be compared to the address mask 550 of the memory access control registers 525 and determine a match. Command 530a includes address 535a with a value of 0b 1010 0110 0000 0000 0000 0000 0001 0000. This value falls within the address ranges of memory access control registers 525c and 525b. Since memory access control register 525b has a higher priority, the set of attributes 551 from this register are used, resulting in overrides 545a being assigned to command 530a. As shown, all three override attributes are included in command 530a. In other embodiments, only a portion of the attributes may be appended to the command, while other attributes are enforced within the memory access circuit without altering the memory access command.

As illustrated, command 530b may be received after command 530a. Command 530b specifies address 535b that is located within the address ranges of memory access control registers 525a, 525b, and 525c. Command 530b is performed using overrides 545b, corresponding to set of attributes 551 that have been programmed into memory access control register 525a, instead of sets of attributes 551 for memory access control registers 525b and 525c, since memory access control register 525a has a higher priority than memory access control registers 525b and 525c.

Command 530c may be received next and includes address 535c that is located within the address range of memory access control register 525c, but not the address ranges of memory access control register 525a or 525b. Accordingly, command 530c is performed using overrides 545c, corresponding to set of attributes 551 of memory access control register 525c.

It is noted that the example of FIG. 5 is included for demonstration of the disclosed concepts. Although three attributes are shown, any suitable number of attributes may be included in the memory access control registers. For example, a single bit is used to indicate if the defined address range is cacheable, without reference to any particular level of cache. In other embodiments, separate attribute bits may be used to indicate cacheability of the address range at different cache levels. The example of FIG. 5 assumes that the memory circuit is byte addressable. In other embodiments, any suitable number of bits may be accessed by a given address.

The embodiments described in regards to FIGS. 1-5 have been described in reference to a single processor core. Use of the disclosed concepts may be applied to embodiments that include multicore processors. Accordingly, FIG. 6 illustrates an example of using memory access control registers in a multicore processor.

### Multicore Computer System Overview

Turning now to FIG. 6, a multicore computer system that utilizes memory access control registers is shown. As illustrated, system 600 includes processor cores 601a-601c (collectively, processor cores 601), memory circuit 650, memory interface circuit 645, and global memory access control registers 628. Each of processor cores 601 includes a respective set of memory access control registers 625a-625c and local memory 660a-660c (collectively, memory access control registers 625 and local memories 660). Any one of processor cores 601 may perform a memory access command for accessing one or more locations in memory circuit 650 and/or a respective local memory 660.

As shown, processor cores 601 include a respective set of memory access control registers 625, these register including a programmable address field indicative of an address range in the system memory map, and an attribute override field, such as illustrated in FIG. 5. A default set of attributes 655 may further be available to processor cores 601, e.g., hardcoded into the core's logic circuits such as load-store circuits and instruction fetch circuits. Memory access control registers 625 may provide an option for overriding such hardcoded defaults. As previously described, some attributes (e.g., access ordering) may be enforced within a processor core 601 performing a memory access command and, therefore, these attributes are not appended to a command sent to memory interface circuit 645. Other attributes, such as cacheability, may be enforced by circuits external to the processor core 601 performing the memory access command and, therefore, are appended to the respective command.

In response to receiving a memory access command from one of processor cores 601, memory interface circuit 645 may be configured to access one or more memory circuits, including memory circuit 650, based on a system memory map using a default set of attributes for an address space associated with the system memory map. As shown, memory interface circuit 645 accesses memory circuit 650 using the default set of attributes 655. This default set of memory attributes 655 may be overridden in a memory access command by the respective processor core 601 that issues the command. In some embodiments, any default attributes that memory interface circuit 645 enforces may be appended to the memory access command by the respective processor core 601. In other embodiments, logic circuits within memory interface circuit 645 may be hardcoded with some or all of the default set of attributes 655.

As illustrated, each of processor cores 601 includes a respective one of local memories 660. A respective one of local memories 660 for a given processor core 601 is not accessible by other ones of processor cores 601. Additionally, a given one of processor cores 601 is configured to use a default set of attributes for its respective local memory 660.

For example, a particular processor core (e.g., processor core 601b) is configured to store a respective value to at least one of memory access control registers 625b. The respective values may determine one or more attribute override values for at least a portion of local memory 660b and/or memory circuit 650. Processor core 601b is configured to receive a command for performing a memory access, the command specifying a target address corresponding to a location in the system memory map. The received command may, e.g., correspond to code in a software process being executed by processor core 601b. In some embodiments, a memory access circuit within processor core 601b may generate the memory access command based on this code.

To perform the memory access command, processor core 601b compares a target address to an address range indicated by one or more of memory access control registers 625b. In response to a determination that the target address is located within a particular address range of a particular one of memory access control registers 625b, processor core 601b sends the memory access command to memory interface circuit 645 using the respective attribute override field of the particular one of memory access control registers 625b. In a manner similar as described above in regards to FIG. 5, processor core 601b determines if the target address falls within an address range of any of memory access control registers 625b.

As illustrated, a different processor core of processor cores 601 (e.g., processor core 601a) is configured to receive a different command for performing a memory access to the same target address as accessed by processor core 601b. Processor core 601a is further configured to compare the target address to an address range indicated by one or more of memory access control registers 625a. In response to a determination that the target address is located within a particular address range of a different one of memory access control registers 625a, processor core 601a may send the command to memory interface circuit 645 using the respective attribute override field of the different one of memory access control registers 625a. Since memory access control registers 625 may be programmed with different values between the different processor cores 601, the attribute override field of the different one of memory access control registers 625a may have a different value than the attribute override field of the particular one of memory access control registers 625b. Memory access control registers 625a and 625b may be limited to use by processor cores 601a and 601b, respectively, allowing each processor core 601 to have a particular set of attributes for memory circuit 650 and other memory locations within an address space of system 600. In other cases, all memory access control registers 625 may be programmed to a same set of values based, for example, on various types of memory circuits used for different address ranges.

Some embodiments of system 600 may include global memory access control registers 628 that are accessible to each of processor cores 601. Global memory access control registers, therefore, may be used to program a particular set of attribute overrides that are common to two or more of processor cores 601. This may allow the respective memory access control registers 625 to be used for programming attribute overrides that are specific to the corresponding one of processor cores 601.

As shown, processor cores 601a and 601b may be further configured to compare the target address to a respective address range indicated by one or more of global memory access control registers 628. In response to a determination that the target address is located within a given address range of a given one of global memory access control registers 628, processor core 601b, for example, determines a priority between the given one of global memory access control registers 628 and the particular one of memory access control registers 625b. Processor core 601b may send the command to memory interface circuit 645 using the respective attribute override field of the particular one of memory access control registers 625b in response to a determination that the particular one of memory access control registers 625b has a higher priority than the given one of global memory access control registers 628. In some embodiments, the address range of the particular one of memory access control registers 625b may be smaller than the address range of the given one of global memory access control registers 628, thereby establishing two or more hierarchical levels attribute overrides. Use of such hierarchal levels may provide flexibility in how memory locations are accessed by given ones of processor cores 601.

As illustrated in FIG. 6, memory attributes may be assigned in a flexible manner allowing a combination of global override attributes as well as specific overrides for particular processor cores. For example, processor core 601a may execute processes related to an operating system of system 600. Processor core 601b, in contrast, may perform processes related to a given application. In some cases, it may be preferable to enable different attributes for the operating system when accessing memory circuit 650 than for the application. Additionally, it may be desirable to allocate memory to the application such that the application is allowed greater flexibility in accessing the allocated memory than the operating system. For example, a first range of memory addresses may be allocated to the operating system and a second, non-overlapping range allocated to the application. Attributes may be set such that processor core 601a can cache memory at addresses of the first range, but not the second, and vice versa for processor core 601b.

It is noted that the example of system 600 is an example for demonstrating disclosed concepts. A number of depicted elements of system 600 is limited for clarity. In other embodiments, additional elements may be included, such as a different number of processor cores, memory circuits, and/or memory interfaces. Although not illustrated, one or more cache memories may be included in some embodiments.

To summarize, various embodiments of a processor are disclosed. Broadly speaking, apparatus, systems, and methods are contemplated in which an embodiment of an apparatus, for example, includes a plurality of memory access control registers that are programmable with respective address ranges within an address space. The apparatus further includes a memory access circuit configured to receive a command for performing a memory access, the command specifying an address corresponding to a location in a memory circuit. In response to the address being located within an address range of a particular one of the plurality of memory access control registers, the memory access circuit is configured to perform the command using override memory parameters that have been programmed into the particular memory access control register instead of a default set of attributes for the address space.

In a further example, the memory access circuit may be further configured to receive a different command for performing a different memory access, the command specifying a different address that is located within the address range of the particular memory access control register. In response to the different address being located within an address range of a different one of the plurality of memory access control registers, the memory access circuit may be configured to perform the command using override memory parameters that have been programmed into the different memory access control register instead of the override memory parameters of the particular memory access control register. The different memory access control register may have a higher priority than the particular memory access control register.

In another example, each of the plurality of programmable memory access control registers may be assigned a respective priority. The memory access circuit may be further configured to use the override memory parameters from the particular memory access control register in response to a determination that the particular memory access control register has the highest priority of all memory access control registers that have corresponding address ranges.

In one embodiment, the memory access circuit includes an instruction fetch circuit and a load-store circuit. The instruction fetch circuit may be configured to use the plurality of programmable memory access control registers for memory access commands. The load-store circuit may be configured to use a different plurality of programmable memory access control registers for memory access commands.

In another embodiment, the memory access circuit includes an instruction fetch circuit and a load-store circuit. The instruction fetch circuit may be configured to use a first set of comparators to compare addresses of memory access commands from the instruction fetch circuit to the plurality of programmable memory access control registers. The load-store circuit may be configured to use a second set of comparators to compare addresses of memory access commands from the load-store circuit to the plurality of programmable memory access control registers.

### Methods for Utilizing Memory Attribute Overrides

The circuits and examples described in FIGS. 1-6 may be implemented using various methods. In FIGS. 7 and 8, two such methods are presented and described below.

Proceeding now to FIG. 7, a flow diagram for an embodiment of a method for using memory access control registers is illustrated. Method 700 may be used in conjunction with any of the computer circuitry, systems, devices, elements, or components disclosed herein, such as processor cores 101, 401a, 401b, and 601, among others. In some embodiments, processor core 101 may have access to a non-transient, computer-readable medium having program instructions stored thereon that are executable by processor core 101 to cause the operations described with reference to FIG. 7. Method 700 is described below using system 100 of FIG. 1 as an example. References to elements in FIG. 1 are included as non-limiting examples.

Method 700 begins in block 710 by initializing, by a processor, at least one of a plurality of programmable memory access control registers with respective address values, the respective address values indicating a corresponding address range within an address space. For example, processor core 101 may store respective values into one or more of memory access control registers 125. As shown, a value of address range 140 may establish a starting address and a number of addresses included in an address range associated with memory access control register 125b. Addresses within this established address range may be accessed using attributes as defined by overrides 145. Such attributes, as disclosed above, may include, for example, cacheability, side-effects, and ordering. Values to be written to ones of memory access control registers 125 may be determined from boot code, an operating system, an application, or other code received and executed by processor core 101.

At 720, method 700 continues by generating, by a memory access circuit in the processor, a command for performing a memory access, the command specifying an address corresponding to a location in a memory circuit. Memory access circuit 120, for example, may receive command 130 that includes address 135. In some embodiments, command 130 may be an instruction fetch generated by an instruction fetch circuit. In other embodiments, command 130 may be a load/store instruction being processed by a load-store circuit. In further embodiments, command 130 may be a different type of command (e.g., integer operation) that uses an operand that needs to be retrieved from address 135, thereby causing processor core 101 to initiate a memory command to read a value from address 135.

In response to determining that the address is located within an address range of a particular one of the plurality of memory access control registers, method 700 continues at 730 by performing, by the memory access circuit, the command using override memory parameters that have been programmed into the particular memory access control register instead of a default set of attributes for the address space. To perform command 130, memory access circuit 120 may, for example, first determine whether one or more overrides have been defined for address 135. To determine if overrides have been defined, memory access circuit 120 may compare address 135 to address range values for ones of memory access control registers 125. If address 135 is determined to fall within an address range of a programmed one of memory access control registers 125 (e.g., memory access control register 125b) then memory access circuit 120 may perform command 130 using attributes as defined by overrides 145. If, however, address 135 does not fall within a defined address range of any of memory access control registers 125, then memory access circuit 120 may perform command 130 using the default set of attributes 155.

In some embodiments, memory access control registers 125 may have respective priority levels. If address 135 falls within an address range of more than one of memory access control registers 125, then memory access circuit 120 may use overrides associated with a highest priority one of memory access control registers 125. Relative priorities of the registers may be determined based on respective locations of the memory access control registers 125 within a register block containing these registers.

It is noted that the method of FIG. 7 includes elements 710-730. Method 700 may end in 730 or may repeat some or all elements of the method. For example, method 700 may return to 720 to receive a next command for performing a memory access. In some cases, method 700 may be performed concurrently with other instances of the method. For example, processor core 101 may be capable of executing two or more process threads concurrently, or system 100 may include a plurality of processor cores. In such embodiments, memory access commands from different process threads may be processed concurrently, including the operations of method 700. Although three operations are illustrated in FIG. 7, additional operations may be included in some embodiments. For example, an additional operation may include determining which one of memory access control registers has a highest priority if an address of a command falls within the address range of more than one.

Turning to FIG. 8, a flow diagram of an embodiment of a method for determining priorities between memory access control registers is illustrated. In a similar manner as method 700, method 800 may be performed by a processor such as processor cores 101, 401a, 401b, and 601 in various ones of FIGS. 1-6. The processor may, for example, include (or have access to) a non-transient, computer-readable medium having program instructions stored thereon that are executable by the processor to cause the operations described with reference to FIG. 8. In some embodiments, method 800 may be performed, for example, between operations 720 and 730 of method 700. Method 800 is described below using FIGS. 1 and 2 as examples. References to elements in FIGS. 1 and 2 are included as non-limiting examples. As described, method 800 may be performed after operation 720 of method 700, prior to determining that an address of a command falls within an address range of a particular memory access control register.

After receiving a memory access command, including a specified address, method 800 begins at 810 by comparing a portion of the specified address to a respective address value included in a different one of the plurality of memory access control registers, the different memory access control register having a higher priority than the particular memory access control register. For example, command 230, including address 235, may be received by memory access circuit 120 in processor core 101. To determine if address 235 falls within an address range of any of memory access control registers 125, memory access circuit 120 may begin with the one memory access control register 125 with the highest priority. If address 235 falls within the address range of the memory access control register with the highest priority, then memory access circuit 120 may not compare address 235 to any other address ranges and perform command 230 using the overrides programmed into the register with the highest priority. As described in regards to FIG. 5, a portion of address 235 may be used based on an address mask value in the respective memory access control registers used to determine the address range.

In response to determining that the portion of the specified address does not correspond to the different memory access control register, method 800 continues at 820 by comparing the portion of the specified address to the respective address value of the particular memory access control register. After receiving command 230, memory access circuit 120 may, for example, compare the portion of address 235 to address ranges of memory access control registers 125 beginning with the highest priority one, memory access control register 125a. If address 235 does not fall within the address range of memory access control register 125a, then the address range of 125b is compared, followed by 125c, 125d, and so on until it is determined that address 235 falls within the address range of memory access control register 125i. At this point, it is known that memory access control register 125i has a highest priority of any memory access control registers 125 with address ranges corresponding to address 235 since the registers with higher priorities have already been checked. Accordingly, in the present example, address ranges for memory access control registers 125j-1251 are not compared to address 235 (or the comparisons may occur, but further matches disregarded) and memory access circuit 120 proceeds to perform command 230 using attribute overrides 245d of memory access control register 125i.

Variations of method 800 are contemplated. For example, in some embodiments, address 235 may be compared to all memory access control registers 125 in parallel. The overrides programmed into the register with the highest priority may then be used with command 230. Combinational logic may be used to perform the comparison with the attributes from the highest priority one of memory access control registers 125 being produced as an output of the logic circuit. In other embodiments, a cascading logic circuit may asynchronously compare address 235 to each of memory access control registers 125 in order of highest to lowest priority, disabling the logic of subsequent comparisons once a match is determined. In various embodiments, the outputs of such logic circuits may be an indication of the highest priority matching one of memory access control registers 125 and/or the corresponding attributes.

It is noted that methods 700 and 800 are merely examples for demonstrating the disclosed techniques. It is contemplated that operations of methods 700 and 800 may be interchanged as suitable. For example, method 800 may be performed as part of method 700, e.g., as a part of, or immediately following, operation 720. Accordingly, method 800 may end at 820 or may proceed to operation 730 of method 700. Although only operations 810 and 820 are illustrated, in other embodiments, method 800 may include additional operations, e.g., repeating comparisons to other ones of the plurality of memory access control registers until a corresponding address range is identified.

### Systems Utilizing Memory Attribute Overrides

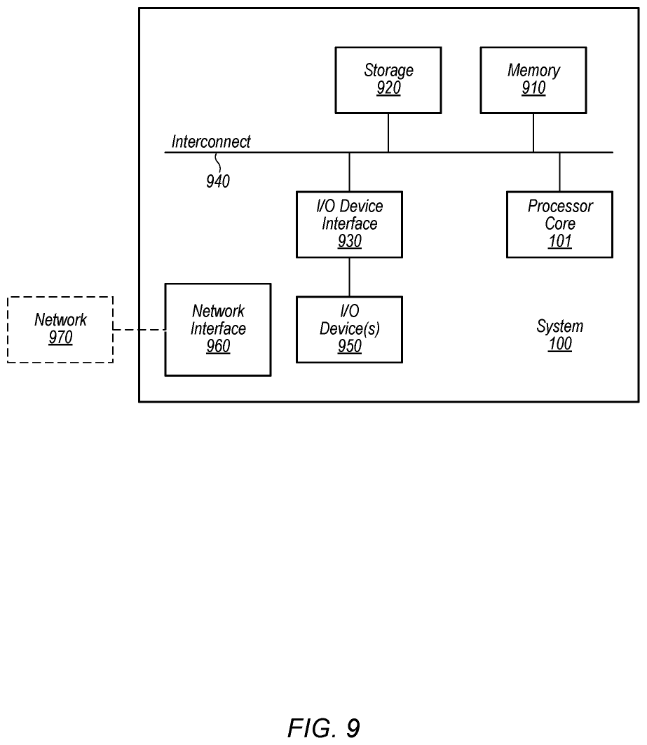

Systems 100 and 600, described above with reference to various figures, may be included within a variety of system configurations. An example configuration of system 100 is shown in FIG. 9. In various embodiments, system 100 may correspond to a general-purpose computer system, such as a desktop or portable computer, a mobile phone, or the like. System 100 may also correspond to any type of embedded system that may employ one or more instances of processor cores 101 as a dedicated controller. For example, system 100 may correspond to any type of computer peripheral device such as a mass storage device or storage array, printer, or the like, as well as control systems for automobiles, aviation, manufacturing, and other suitable applications. Although FIG. 9 is presented as an example of system 100, it is contemplated that similar elements of FIG. 9 may be included in system 600 of FIG. 6.

As shown, system 100 includes processor core 101 from FIG. 1. In addition, system 100 may include memory 910, storage 920, and input/output (I/O) device interface 930 coupled via interconnect 940. One or more I/O devices 950 are coupled via I/O device interface 930. System 100 also includes network interface 960 that may be configured to couple system 100 to network 970 for communications with, e.g., other systems. (In various embodiments, network interface 960 may be coupled to interconnect 940 directly, via I/O device interface 930, or according to a different configuration.) It is noted that some or all of the components of system 100 may be fabricated as a system-on-a-chip, although discrete combinations of components may also be employed.

In addition to elements described above, processor core 101 may include cache memory circuits and prefetch circuits. Memory 910 may include random-access memory (RAM) of any suitable configuration, such as working memory configured to store data and instructions usable by processor core 101. In some embodiments, memory 910 may include nonvolatile memory circuits. Storage 920 may include mass storage devices such as magnetic, optical, or nonvolatile/flash memory storage, or a combination of these. In some embodiments, memory 910 and/or storage 920 may be included in memory circuits 150 of FIGS. 1 and 3. Either of memory 910 or storage 920 may, in some embodiments, be omitted or integrated into the other as a single memory subsystem from the perspective of processor core 101.

I/O device interface 930 may be configured to interface between interconnect 940 and one or more other types of buses or interfaces. For example, interconnect 940 may correspond to the advanced high-bandwidth bus (“AHB”) interface or another suitable type of high-bandwidth interconnect, and I/O device interface 930 may be configured as a bridge device that enables coupling of different types of I/O devices to interconnect 940. I/O device interface 930 may implement one or more interface protocols such as Universal Serial Bus, Firewire, or other suitable standards. I/O device(s) 950 may include any suitable type of storage, network interface, user interface, graphics processing, or other type of device. Network 970, if present, may be any suitable type of wired or wireless communications network, such as an Internet Protocol (IP) addressed local or wide-area network, a telecommunications network, or the like. Network interface 960, if present, may be configured to implement any suitable network interface protocol needed for communication with network 970.

The systems illustrated in FIG. 9 may benefit from the techniques disclosed herein. For example, use of memory access control registers in the processor cores used in these systems may improve efficiency of memory allocations, resulting in higher performance, lower power consumption, lower costs, or a combination thereof.

The present disclosure includes references to an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent claims that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of task or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), functional unit, memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement and such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used to transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits or portions thereof may also be custom-designed in a schematic editor and captured into the integrated circuit design along with synthesized circuitry. The integrated circuits may include transistors and other circuit elements (e.g. passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

1. An apparatus, comprising:
a plurality of memory access control registers that are programmable with respective address ranges within an address space; and
a memory access circuit configured to:
generate a command for performing a memory access, the command specifying an address corresponding to a location in a memory circuit; and
in response to the address being located within an address range of a particular one of the plurality of memory access control registers, perform the command using override memory parameters that have been programmed into the particular memory access control register instead of a default set of attributes for the address space, wherein at least one value of the override memory parameters that have been programmed into the particular memory access control register is appended to the command.

2. The apparatus of claim 1, wherein the memory access circuit is further configured to:
generate a different command for performing a different memory access, the command specifying a different address that is located within the address range of the particular memory access control register; and
in response to the different address being located within an address range of a different one of the plurality of memory access control registers, perform the command using override memory parameters that have been programmed into the different memory access control register instead of the override memory parameters of the particular memory access control register, wherein the different memory access control register has a higher priority than the particular memory access control register.

3. The apparatus of claim 1, wherein each of the plurality of memory access control registers is assigned a respective priority, and wherein the memory access circuit is further configured to use the override memory parameters from the particular memory access control register in response to a determination that the particular memory access control register has a higher priority than other memory access control registers that have corresponding address ranges.

4. The apparatus of claim 1, wherein the memory access circuit includes:
an instruction fetch circuit configured to use the plurality of programmable memory access control registers for memory access commands; and
a load-store circuit configured to use a different plurality of programmable memory access control registers for memory access commands.

5. The apparatus of claim 1, wherein the memory access circuit includes:
an instruction fetch circuit configured to use a first set of comparators to compare addresses of memory access commands from the instruction fetch circuit to the plurality of programmable memory access control registers; and
a load-store circuit configured to use a second set of comparators to compare addresses of memory access commands from the load-store circuit to the plurality of programmable memory access control registers.

6. The apparatus of claim 1, wherein ones of the plurality of memory access control registers include an address mask field, and wherein a value of the address mask field determines a start address and a size of a respective address range for a given memory access control register.

7. The apparatus of claim 1, wherein to perform the command using the override memory parameters, the memory access circuit is configured to append at least one override memory parameter from the particular memory access control register to the command.

8. A method, comprising:
initializing, by a processor, at least one of a plurality of programmable memory access control registers with respective address values, the respective address values indicating a corresponding address range within an address space;
creating, by a memory access circuit in the processor, a command for performing a memory access, the command specifying an address corresponding to a location in a memory circuit; and
in response to determining that the address is located within an address range of a particular one of the plurality of memory access control registers, performing, by the memory access circuit, the command using override memory parameters that have been programmed into the particular memory access control register instead of a default set of attributes for the address space, wherein at least one value of the override memory parameters that have been programmed into the particular memory access control register is appended to the command.

9. The method of claim 8, wherein ones of the plurality of memory access control registers have respective priority levels based on respective locations of the plurality of memory access control registers within a register block.

10. The method of claim 9, wherein determining that the address is located within the address range of the particular one of the plurality of memory access control registers includes:
comparing a portion of the specified address to a respective address value included in a different one of the plurality of memory access control registers, the different memory access control register having a higher priority than the particular memory access control register; and
in response to determining that the portion of the specified address does not correspond to the different memory access control register, comparing the portion of the specified address to the respective address value of the particular memory access control register.

11. The method of claim 8, wherein the default set of attributes for the address space includes:
an indication of whether information in a given address is cacheable; and
an indication of whether information in a given address has side-effects when accessed.

12. The method of claim 8, further comprising:
mapping the specified address of the command from a virtual address to a physical address; and
comparing the physical address to the address range of the particular memory access control register.

13. The method of claim 8, wherein the respective address values indicate both a starting address and a size of the corresponding address range.

14. A system, comprising:
a memory interface circuit configured to access one or more memory circuits based on a system memory map using a default set of attributes for an address space associated with the system memory map; and
a plurality of processor cores, wherein ones of the processor cores include a respective set of memory access control registers including a programmable address field indicative of an address range in the system memory map, and an attribute override field; and
wherein a particular processor core of the plurality of processor cores is configured to:
generate a command for performing a memory access, the command specifying a target address corresponding to a location in the system memory map;
compare the target address to an address range indicated by one or more of the respective sets of memory access control registers; and
in response to a determination that the target address is located within a particular address range of a particular one of the one or more memory access control registers, send the command to the memory interface circuit using the respective attribute override field of the particular memory access control register wherein at least one value of the override memory parameters that have been programmed into the particular memory access control register is appended to the command.

15. The system of claim 14, wherein one of the processor cores include a respective local memory space, including one or more registers;
wherein a local memory space for the particular processor core is not accessible by other ones of the plurality of processor cores; and
wherein the particular processor core is further configured to use a default set of attributes for the local memory space.

16. The system of claim 15, wherein the particular processor core is further configured to store a particular value to at least one of the respective set of memory access control registers; and
wherein the particular value determines one or more attribute override values for at least a portion of the local memory space.

17. The system of claim 14, wherein a different processor core of the plurality of processor cores is configured to:
receive a different command for performing a memory access, the command specifying the target address;
compare the target address to an address range indicated by one or more respective memory access control registers of the different processor cores; and
in response to a determination that the target address is located within a particular address range of a different one of the one or more memory access control registers of the different processor core, send the command to the memory interface circuit using the respective attribute override field of the different memory access control register, wherein the attribute override field of the different memory access control register has a different value than the attribute override field of the particular memory access control register.

18. The system of claim 14, further including a set of global memory access control registers accessible to the plurality of processor cores.

19. The system of claim 18, wherein the particular processor core is further configured to:
compare the target address to an address range indicated by one or more of the global memory access control registers;
in response to a determination that the target address is located within a given address range of a given one of the global memory access control registers, determine a priority between the given global memory access control register and the particular memory access control register; and
send the command to the memory interface circuit using the respective attribute override field of the particular memory access control register in response to a determination that the particular memory access control register has a higher priority than the given global memory access control register.

20. The system of claim 19, wherein the address range of the particular memory access control register is smaller than the address range of the given global memory access control register.
